(19) United States
(12) Patent Application Publication
(10) Pub. No.: US 2011/0029687 A1
(43) Pub. Date: Feb. 3, 2011

(54) DATA TRANSMISSION IN A RING-TYPE COMMUNICATION NETWORK

(75) Inventors: Hubert KIRRMANN, Daettwil (CH); Jean-Charles Tournier, Bellegarde sur Valserine (FR)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 12/846,146

(22) Filed: Jul. 29, 2010

(30) Foreign Application Priority Data
Jul. 31, 2009 (EP) 09166937.4

(51) Int. Cl. G06F 15/16

(52) U.S. Cl. 709/236

(57) ABSTRACT

Exemplary embodiments are directed to deterministic data transmission of real-time operational data in Highly available, Seamlessly Redundant (HSR) ring-type communication networks with at least a master node, a source node, and a destination node. Each node can include first and second communication ports connected to a respective first and second neighbouring node of the communication network, to receive a frame via the first communication port, and to forward the received frame via the second communication port. The master node sends a first and a second redundant frame or empty data packet to its first and second neighbouring node, respectively. Upon reception of the two redundant frames, the source node inserts process data into a predetermined and dedicated field of each frame. Each one of the two loaded redundant frames is instantaneously and individually forwarded to the first and the second neighbouring node of the source node, respectively. The destination node extracts the process data from the first arriving loaded redundant frame of the pair.

### RELATED APPLICATION

This application claims priority under 35 U.S.C. §119 to European Patent Application No. 09166937.4 filed in Europe on Jul. 31, 2009, the entire content of which is hereby incorporated by reference in its entirety.

### FIELD

The disclosure relates to the field of deterministic industrial communication systems using redundant communication networks for controlling mission-critical processes, such as processes used for vehicle control, drive control or substation automation.

### BACKGROUND INFORMATION

In industrial communication systems for vital or otherwise mission-critical applications such as vehicle control, drive control or substation automation, availability and reliability can be key issues, because a failing communication system may lead to an interruption of the application and to a shutdown of a process controlled by the latter. Therefore, communication network redundancy is a desired feature of industrial communication systems demanding high availability, such as those using Ethernet-based communication with commercial switches.

A high level of redundancy with seamless operation in case of failure may be provided by duplicating the communication lines (e.g., the electrical or optical transmission cable, as well as at least the physical layer of the corresponding protocol stack of the devices attached to each of the two local area networks through two independent transceivers and bus controllers). For each frame to be transmitted a sender simultaneously sends two frames, one over each line, and the receiver accepts whichever frame of such a pair of redundant frames comes first and discards the later frame. Switchover is seamless, since there is no need to repeat a frame in case of disruption of one path. The tagging of redundant frames can offer a complete supervision of both redundant lines with normal traffic, ensuring a high coverage. This method has been described in patent application WO 2006/053459 and standardized as Parallel Redundancy Protocol (PRP) in IEC standard 62439, the disclosures of which are hereby incorporated by reference in their entireties. However, the PRP involves a complete and hence rather uneconomical duplication of the physical network.

A ring topology can provide a more cost-effective solution, especially when the switching element is integrated within the node (forming a switching end node), offering a similar availability as PRP but often suffering from long recovery delays of up to a few ms. In a ring network, every node has two communication ports connecting to two neighbour nodes hence the ring network can be operated in either or both directions and thus offers resiliency against link failure. Ring networks such as FDDI or Token Ring are state-of-the art and can be of the Ethernet type, in which case protocols such as RSTP (IEEE 802.1D) ensure that frames cannot circulate indefinitely on the ring.

Patent Application No. EP 08160883.8 (Publication No. EP 2148473), the disclosure of which is hereby incorporated by reference in its entirety, relates to mission-critical or highly-available applications based on a ring-type communication network with a plurality of switching nodes and operating with full duplex links. A sender node that is connected over a respective first and second port to the communication network transmits pairs of redundant frames. For each frame to be sent on the ring network, a source and a duplicate frame are transmitted in opposite directions, both frames being relayed by the other nodes of the ring network until they eventually return back to the originating sender node. As a consequence, network load is roughly doubled with respect to a known ring network, but the destination node will receive the data after a maximum transmission delay that equals to the longest possible path of the ring. In the fault-free state, the destination node thus receives two redundant frames with the same contents. The redundant frames can be identified according to the Parallel Redundancy Protocol PRP above, hence only the earlier or first frame of the two frames is forwarded to the upper layer protocols and the later or second frame is discarded. In a known variant of the disclosure, to prevent frames from circulating indefinitely in the ring, the originating sender node does not relay a frame that it had previously sent itself.

Substations in high and medium-voltage power networks include primary devices such as electrical cables, lines, bus bars, switches, power transformers and instrument transformers, which are generally arranged in switch yards and/or bays. These primary devices are operated in an automated way via a Substation Automation (SA) system. The SA system includes microprocessor based, programmable secondary devices, so-called Intelligent Electronic Devices (IED) responsible for protection, control and/or monitoring of the primary devices. The IEDs can be assigned to one of three hierarchical levels (e.g., the station level, the bay or feeder level, and the process level). The station level of the SA system includes an Operator Work Station (OWS) with a Human-Machine Interface (HMI) and a gateway to a Network Control Centre (NCC). IEDs on the bay level, also termed bay units, in turn are connected to each other and to the IEDs on the station level via an inter-bay or station bus. The station bus is covered by the part 8-1 of the IEC standard 61850 “communication networks and systems in substations” stipulating protocols (e.g. Manufacturing Message Specification MMS or Generic Object Oriented Substation Events GOOSE) that are not demanding in terms of network load (a few packets per seconds) and synchronization (e.g., 1 ms can be involved), and aim at transmitting commands to the bay controllers, but also report events, such as alarm or status changes.

On the other hand, the process interface linking the process level to the bay level includes a process bus that is covered by the part IEC61850-9-2 of the above standard. A task of the process bus is to transmit measurement values (Sampled Values SV) from the instrument transformers or merging units to the protection devices and trip commands (GOOSE) from the protection devices to the switchgear. Unlike the station bus, the process bus can involve high availability (e.g., the sampled values sending rate is between 4 kHz and 12 kHz) and strict real-time constraints (e.g., the sampled values are to be delivered to the protection application less than 3 ms after they have been produced) in order to perform protection functions correctly.

While the availability of the samples values data is clearly addressed by the above redundant protocol, the real-time operability remains an open issue. The IEC 61850-9-2 protocol for Sampled Values is based on Ethernet and therefore can only provide a best effort guarantee concerning the delay for data delivery. Moreover, the protocol prioritizes the packets already circulating in the ring over the ones that need to be sent by a node. This property can lead to a mute node (e.g., a node constantly forwarding packets from one port to the other without being able to send its own packets).

Real time protocols have been extensively studied over the past 30 years, and two exemplary approaches are found to guarantee a real-time property to a communication protocol. According to these approaches, either the communication medium is reserved at a certain time and for a given delay (e.g. Time Triggered Controller Area Network TTCAN), or a packet is circulating periodically on the medium in which each node inserts or retrieves the data at a fixed position (e.g. EtherCAT). EtherCAT applies Ethernet to automation applications which involve short data update times or cycle times, wherein the Ethernet packet, frame or telegram is no longer received, interpreted and copied as process data at every node. The EtherCAT slave devices read the data addressed to them, and insert input data, while the frame passes through the device. The frames are delayed by a fraction of a microsecond in each node, and many nodes—(e.g., the entire network) can be addressed with just one frame.

### SUMMARY

A method is disclosed of transmitting data in a ring-type communication network with a master node, a source node and a destination node connected to respective first and second neighbouring nodes of the communication network, the method comprising: sending, by the master node, first and second redundant frames of a pair of redundant frames to the first and the second neighbouring nodes of the master node, respectively; inserting, by the source node, identical process data into a predetermined field of each of the first and second redundant frames of the pair of redundant frames for forwarding two loaded redundant frames including said process data to the first and the second neighbouring node of the source node, respectively; and extracting, by the destination node, the process data from a first of the two loaded redundant frames received by the destination node.

A ring-type communication network is also disclosed which comprises: a master node; a source node; and a destination node connected to respective first and second neighbouring nodes of the communication network, respectively, wherein: the master node is configured to generate and send first and second redundant frames of a pair of redundant frames to the first and the second neighbouring node of the master node, respectively; the source node is configured to insert identical process data into a predetermined field of each of the first and second redundant frames of the pair of redundant frames for forwarding loaded redundant frames including said process data to the first and the second neighbouring node of the source node, respectively; and the destination node is configured to extract the process data from a first loaded redundant frame received by the destination node.

### BRIEF DESCRIPTION OF THE DRAWINGS

The subject matter of the disclosure will be explained in more detail in the following text with reference to exemplary embodiments which are illustrated in the attached drawings, in which:

FIG. 1 depicts an exemplary automation network with a ring topology;

FIG. 2 illustrates a basic principle of the Real-Time (RT) enabled HSR protocol; and

FIG. 3 illustrates an exemplary structure of an RT-HSR redundant frame.

The reference symbols used in the drawings, and their meanings, are listed in summary form in the list of reference symbols. In principle, identical parts are provided with the same reference symbols in the figures.

### DETAILED DESCRIPTION

Exemplary embodiments disclosed herein can enable real-time and/or deterministic data transmission in ring-type communication networks.

According to exemplary embodiments of the disclosure, Real-Time (RT) operational data can be transmitted in a Highly available, Seamlessly Redundant (HSR) ring-type communication network with at least a master node, a source or publisher node, and a destination or subscriber node. Each one of the nodes can include first and second communication ports connected to a respective first and second neighbouring node of the communication network, and can be adapted to receive a frame via the first communication port, and to forward the received frame, either modified or unmodified, via the second communication port without additional delay. The master node sends, essentially simultaneously, a first and a second redundant frame or empty data packet to its first and second neighbouring node, respectively. Upon reception of a first one of the two redundant frames, the source node inserts process data into a predetermined and dedicated field. The source node subsequently adds the identical process data to a predetermined field of the second or later redundant frame. Once loaded or augmented with process data, both redundant frames are instantaneously and individually forwarded to the first and the second neighbouring node of the source node, respectively. The destination node then extracts or copies the process data from the first arriving loaded redundant frame of the pair.

In an exemplary variant of the disclosure, received loaded redundant frames are forwarded, once the relevant process data has been extracted, by the destination nodes. No elimination criterion is implemented in the destination nodes trying to establish whether or not another node in the ring might be interested in the process data carried by the received frame. Only the master node will eliminate the redundant frames that it had previously launched itself, including for example the loaded redundant frames based on the latter.

In an exemplary embodiment of the disclosure, the master node generates and transmits a sequence of pairs of redundant frames within one cycle. The number of pairs in the sequence depends on the actual number of nodes in the communication ring, which may thus exceed the number of nodes defined by the payload capacity of one single frame.

In a further exemplary embodiment of the disclosure, the operational process data comprises Sampled Measured Values (SMV) according to IEC 61850 9-2, provided to the source node by a current or voltage sensor connected to a high or medium voltage substation of an electric power system, or connected to a wind power, a hydro power or a Distributed Energy Resources (DER) system. The source node may additionally include GOOSE data in the same frame.

With an exemplary protocol as disclosed herein, a dedicated synchronization protocol such as IEEE 1588 is no longer required to synchronize the different devices connected to the communication ring. In exemplary embodiments disclosed herein, if the master node is synchronized, by whatever means, with the rest of the substation, the master will, via the empty RT-HSR redundant frames cyclically sent at e.g. 4 kHz, inherently synchronize or syntonize the other devices on the ring.

In order to avoid a single point of failure, a further exemplary variant of the protocol described includes the provision of a backup or redundant master node in the ring. The latter is assumed to be synchronized with the primary master node, and to have an internal clock of the same kind and quality as the internal clock of the primary master node. However, instead of having an active redundant master which would double the network load, the backup master operates, for example, in a standby redundancy mode and is adapted to actively detect the failure of the primary master. If the backup master node is located in the vicinity of the primary master, and for example as an immediate neighbour, the backup master node will be able to determine a failure of the primary master node quasi instantaneously. In fact, in case no RT-HSR frame is received by the backup master node before the expiry of a maximum jitter or transmission delay of e.g. 5 μs, the backup master will conclude a primary master failure and in turn start sending redundant frames.

In summary, exemplary embodiments of the present disclosure enable real-time or deterministic data transmission of Sampled Values by using a multiple tokens approach in the HSR protocol. At regular intervals a packet is provided on the ring into which each node will insert the data that needs to be sent. The proposed approach covers the data communication as such (e.g., how can the transport of data on HSR be made predictable, as well as the configuration part, at the initialization stage or after a network topology change). An exemplary RT-HSR protocol as disclosed herein provides both availability and real-time properties for the transport of sampled values on the process bus.

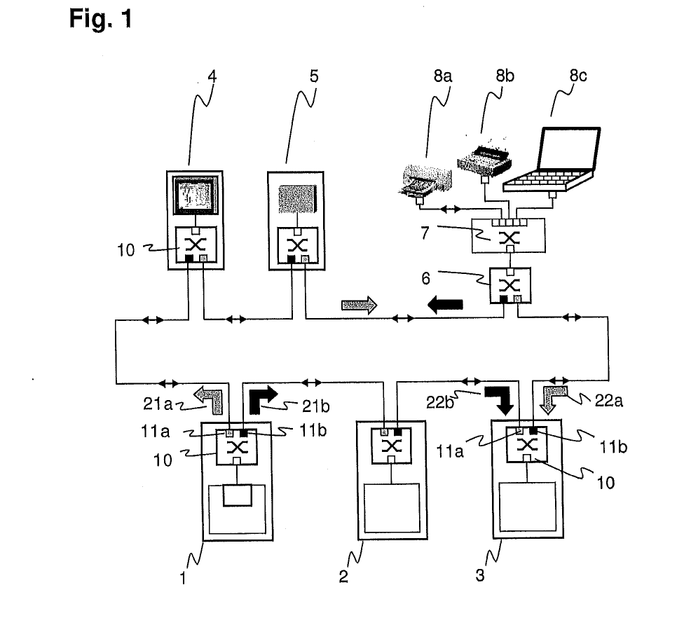

FIG. 1 depicts an exemplary automation network with a ring topology, in which all switching nodes within the ring (1-6), such as protection, control and measuring devices (1-3), supervision workstation (4), clock master (5) as well as intermediary node (6) include a switch element (10) that is able to forward frames from one port (11a, 11b) to the other (11b, 11a), thus ensuring circulation of frames around the ring. The intermediary node (6) connects, via optional non-ring-node-switch (7), to a number of non-ring devices (8a-8c). In the notation of the exemplary embodiments disclosed herein, the switch element of a master node (1) injects two redundant frames (21a, 21b), one in each direction (A, B) of circulation. The switch element (10) of a source node (3) or of a destination node (3) is capable of receiving frames (22a, 22b) from either direction of the ring and of forwarding them, either modified or as received, through the sending port (11a; 11b) opposed to the receiving port (11b; 11a), thus maintaining the original (anti-)clockwise direction of circulation of both redundant frames in the ring. This aspect is in accordance with the original High availability Seamless Redundancy (HSR) ring protocol as discussed in EP 08160883.8, where a node always sends a frame received from its higher layer protocols over both its ports, and the two duplicates of the frame circulate over the bus in opposite direction until they reach their original sender, and where receivers pass only the earlier frame of a pair to their higher layer protocols and discard the duplicate.

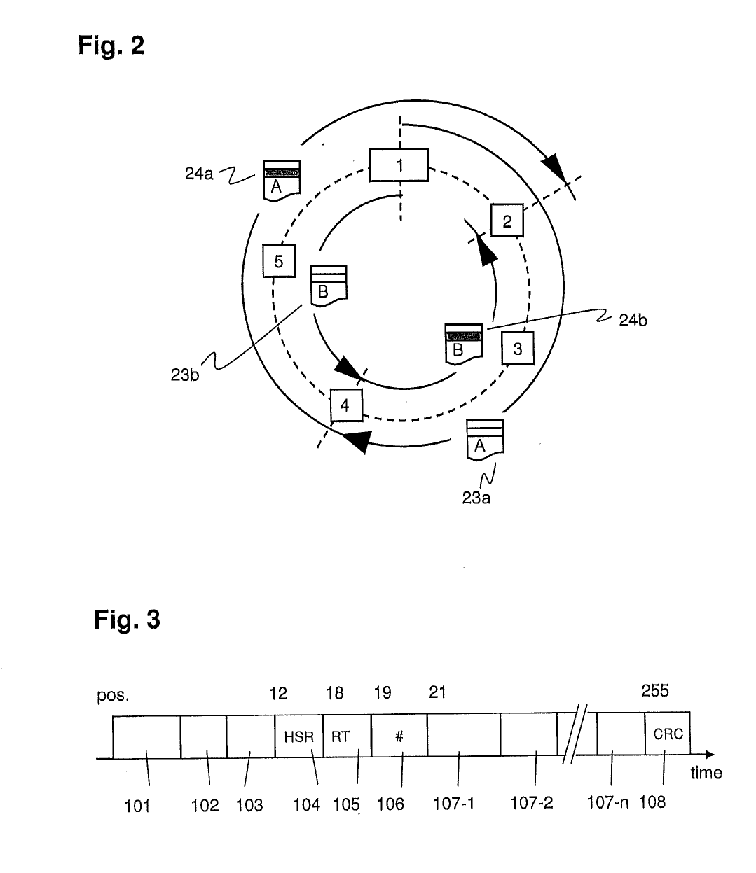

FIG. 2 depicts an exemplary basic principle of the amended and Real-Time (RT) enabled HSR protocol according to exemplary embodiments of the present disclosure in a ring (dashed line) with five nodes (1-5). Master node (1) generates and sends two redundant frames (23a, 23b) of a pair of redundant frames, wherein the frame designated “A” circulates clockwise and the frame designated “B” circulates counter clockwise. As further detailed below, the two redundant frames are originally identical except for some identifier equivalent to “A” or “B”, and include predefined areas for process data to be provided and loaded by a source node. Both frames are forwarded by all nodes in the ring until they are occasionally removed. As soon as the first (23b) of the two redundant frames reaches a source node (4), the latter will insert relevant process data to be published, such as Sampled Values according to IEC 61850, to the frame, and will forward the loaded or augmented frame (24b) to the nearest neighbour node. The same applies to the second redundant frame (23a) reaching the source node at a later time. In FIG. 2, the two loaded redundant frames (24a, 24b) including the process data from the source node are marked with a grey stripe indicative of the added process data The destination node (2) reads and processes the data from the first (24b) of the two loaded redundant frames arriving at the destination node, and discards the data from the second or later frame (24a) in accordance with the principles developed for the Parallel Redundancy Protocol (IEC standard 62439). In order to enable the destination node to tell whether or not the payload field of the source node is empty, the payload field may include a specific header field, or the “empty” payload field may be pre-loaded with a meaningless bit sequence.

Packets are discarded or eliminated by the originator of the packet (e.g., the master node). Care has to be taken in order not to jeopardize redundancy by eliminating loaded frames that might still be first frames at a particular destination node. In other words, eliminating every frame after having circulated a single time in the ring might be premature, while waiting for the frame to complete a second round through the ring represents the safe side.

FIG. 3 shows a RT-HSR redundant frame according to an exemplary embodiment of the disclosure. As in the original HSR protocol, the frame starts with a preamble (101), followed by the destination MAC address (102) that indicates the multicast character of the frame rather than identifying a single destination node, and followed by the source MAC address (103) that identifies the master node as the originator of the frame within the same subnet. The next field (104), at position 12 in the frame, is a HSR tag including (e.g., consisting of for example, six bytes) and including a specific value (0x88) indicative of the fact that the present frame obeys to the HSR protocol, a path, a size of the frame and a sequence number. The field 105, at position 18, indicates the real-time properties of the frame and actually points to the amendment to the original HSR protocol as introduced by the present disclosure. Field 106 is indicative of a sequence number or identifier that is used in case the master node sends a sequence of pairs of redundant framesStarting at position 21, the payload fields 107 assigned to the various nodes of the network follow. Each payload field (107-1 to 107-n) is reserved or pre-assigned to a specific source node (1 to n) and identified by a corresponding intra-frame address or position. The frame is concluded by field 108 having a frame check sequence such as a Cyclic Redundancy Check CRC.

If the number of nodes in the ring exceeds the payload capacity of one single frame, a sequence of pairs of redundant frames is generated by the master node, with the pairs being identified by the sequence number or offset in field 106. This field has a predetermined length of 2 bytes, and thus allows for sequences of up to 65536 pairs. As a consequence, the pre-assigned area of a particular source node can include both the sequence number and the memory location or position within the frame.

The number of messages used to allow each node to send process data is, for example, dependent on the number of nodes and the size of the data sent by each node. For the specific case of SMV data, the 9-2 light edition defines a protocol-specific frame of 150 bytes, which means that 10 different pre-assigned areas can be allocated per redundant frame having a standard Ethernet frame size of 1526 bytes. If an exemplary ring includes 27 nodes (e.g., 27 merging units), the master launches 3 pairs of empty RT-HSR frames at the frequency specified by the IEC 61850 9-2 protocol (i.e. 4 kHz or 12 kHz for Europe).

From a performance point of view, RT-HSR can guarantee access to the network to each node without increasing the traffic load. When considering a 20 nodes ring example, and if 10 of the nodes are merging units providing SMV data (frames of 150 bytes at 4 kHz according to 9-2 light) and 10 are IEDs, the network load when using HSR is 10×4.5 Mbits/sec×2=90 Mbits/sec, while is equal to 2×45 Mbits/sec=90 Mbits/sec when using RT-HSR. From a real-time point of view, each node can communicate with each other in less than (N−2)×RD, with N being the number of nodes in the ring and RD being the residence delay of a frame in the node. With a ring of 20 nodes and a residence delay of 320 nanoseconds (assuming a 100 Mbits/sec network and cut-through forward technique implemented on each node after 32 bits), the maximum delay is 18×320 nanoseconds=5.7 microseconds.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1-6 switching nodes
7 switch to non-ring nodes
8a, 8b, 8c non-ring nodes
10 switch element
11a, 11b communication ports
21a-24a frame circulating in direction A
21b-24b frame circulating in direction B
101-108 fields of an RT-HSR frame

What is claimed is:

1. A method of transmitting data in a ring-type communication network with a master node, a source node and a destination node connected to respective first and second neighbouring nodes of the communication network, the method comprising:
sending, by the master node, first and second redundant frames of a pair of redundant frames to the first and the second neighbouring nodes of the master node, respectively;
inserting, by the source node, identical process data into a predetermined field of each of the first and second redundant frames of the pair of redundant frames for forwarding two loaded redundant frames including said process data to the first and the second neighbouring node of the source node, respectively; and
extracting, by the destination node, the process data from a first of the two loaded redundant frames received by the destination node.

2. The method according to claim 1, comprising:
forwarding, by the destination node, the two loaded redundant frames of the pair; and
eliminating, by the master node, the first and second redundant frames and/or the two loaded redundant frames of the pair.

3. The method according to claim 1, comprising:
sending, by the master node, first and second redundant frames of a plurality of pairs of redundant frames to the first and the second neighbouring nodes of the master node, respectively, wherein two distinct redundant pairs include payload fields for distinct source nodes.

4. The method according to claim 1, wherein the ring-type communication network is part of a Substation Automation SA system for a high or medium voltage substation of an electric power system, the method comprising:
inserting, by the source node, process data comprising Sampled Measured Values SMV data provided to the source node by a current or voltage sensor connected to the substation.

5. The method according to claim 1, wherein a node on the ring is synchronized to the master node based on successive reception of a redundant frame of the pair of redundant frames.

6. The method according to claim 1, wherein the master node is a primary master node, and wherein a backup master node is connected to the communication ring, the method comprising:
detecting, by the backup master node, a failure of the primary master node; and
sending, by the backup master node, first and second redundant frames to neighbouring nodes of the backup master node.

7. A ring-type communication network comprising:
a master node;
a source node; and
a destination node connected to respective first and second neighbouring nodes of the communication network, respectively,
wherein:
the master node is configured to generate and send first and second redundant frames of a pair of redundant frames to the first and the second neighbouring node of the master node, respectively;
the source node is configured to insert identical process data into a predetermined field of each of the first and second redundant frames of the pair of redundant frames for forwarding loaded redundant frames including said process data to the first and the second neighbouring node of the source node, respectively; and
the destination node is configured to extract the process data from a first loaded redundant frame received by the destination node.

8. The communication network according to claim 7, wherein the master node is a primary master node, the network comprising:
a backup master node connected to the communication network and configured to actively detect a failure of the primary master node.

9. The method according to claim 2, wherein the ring-type communication network is part of a Substation Automation SA system for a high or medium voltage substation of an electric power system, the method comprising:
inserting, by the source node, process data comprising Sampled Measured Values SMV data provided to the source node by a current or voltage sensor connected to the substation.

10. The method according to claim 3, wherein the ring-type communication network is part of a Substation Automation SA system for a high or medium voltage substation of an electric power system, the method comprising:
inserting, by the source node, process data comprising Sampled Measured Values SMV data provided to the source node by a current or voltage sensor connected to the substation.

11. The method according to claim 9, wherein a node on the ring is synchronized to the master node based on successive reception of a redundant frame of the pair of redundant frames.

12. The method according to claim 10, wherein a node on the ring is synchronized to the master node based on successive reception of a redundant frame of the pair of redundant frames.

13. The method according to claim 11, wherein the master node is a primary master node, and wherein a backup master node is connected to the communication ring, the method comprising:
detecting, by the backup master node, a failure of the primary master node; and
sending, by the backup master node, first and second redundant frames to neighbouring nodes of the backup master node.

14. The method according to claim 12, wherein the master node is a primary master node, and wherein a backup master node is connected to the communication ring, the method comprising:
detecting, by the backup master node, a failure of the primary master node; and
sending, by the backup master node, first and second redundant frames to neighbouring nodes of the backup master node.
